(19) United States
(12) Patent Application Publication
(10) Pub. No.: US 2010/0094794 A1
(43) Pub. Date: Apr. 15, 2010

(54) STIMULI BASED INTELLIGENT ELECTRONIC SYSTEM

(75) Inventors: G. S. Sridhar, Bangalore (IN); Vishwanath Ramdas, Bangalore (IN); Pradeep Bennur Teregowda, Bangalore (IN)

Correspondence Address: EVERGREEN VALLEY LAW GROUP, 4 North Second Street, Suite 598, SAN JOSE, CA, 95113, US

(73) Assignee: TECHVOYANT INFOTECH PRIVATE LIMITED, Ulsoor, Bangalore (IN)

(21) Appl. No.: 12/525,551

(22) PCT Filed: Feb. 1, 2008
(86) PCT No.: PCT/IN2008/000064

§ 371 Date: Dec. 18, 2009

(30) Foreign Application Priority Data
Feb. 1, 2007 (IN) 234/CHE/2007

(51) Int. Cl. G06N 5/02

(52) U.S. Cl. 706/47; 700/90

(57) ABSTRACT

Stimuli based intelligent electronic system. The intelligent electronic system includes a sensing module which receives at least one transient stimulus. A rule and action module then checks one or more rules for the at least one transient stimulus and updates content list dynamically. Further, the intelligent electronic system includes a play module which plays contents based on updated content list.

### BACKGROUND

1. Technical Field

Embodiments of the invention relate generally to the field of electronic systems and more particularly to embedding intelligence into the electronic systems.

2. Prior Art

An electronic system, for example, an electronic display system is in existence for several years now. The electronic display system provides a new medium for products and services companies to showcase themselves at out of home public locations where users are captive and close to a point of purchase. A network of the electronic display system is owned and managed within a private domain, for example, a shopping mall network. The network is managed using a centrally controlled system where a single or a few administrative users execute tasks, ranging from creating content, distributing and scheduling content to electronic display system. As an advance to the electronic display system owned and managed privately, a publicly managed electronic display system has emerged which allows participation of content owners. A network of the publicly managed electronic display system provides basic services in identifying and deploying content within the network. However, intelligent techniques for identifying and deploying content within the network still lack.

In one existing technique, information related to display personality is presented to a content owner based on which the content owner makes decisions to release contents on an electronic display. However, the information is either manually fed or is largely static in nature. Further, the contents depend on a server or customer choice. The content owner is forced to work with this static information to reach a certain set of audience. This causes low efficacy of the electronic display and a low, marginal or sometimes even a negative impact of the message. For example, on an unusually hot week advertisements for warm clothing appearing on the electronic display facing public.

U.S. patent application publication (20030023698A1), discloses a method and apparatus for remotely configuring and displaying information. However, the information is configured for factors like location, time and date. Further, rules are also corresponding to these factors. Moreover, the information is configured for displaying.

In light of the foregoing discussion there is a need for a technique for an intelligent electronic system.

### SUMMARY

Embodiments of the invention described herein provide an intelligent electronic system.

An example method includes receiving at least one transient stimulus. A content list is then dynamically updated based on one or more rules corresponding to the at least one transient stimulus. Thereafter, contents are played based on updated content list.

Another example method includes playing at least one content list on at least one electronic system. At least one transient stimulus for the at least one electronic system is then received from a remote source or a local source. Thereafter, one or more rules are checked for the at least one transient stimulus. The at least one content list is then dynamically updated based on result of checking. Contents are then played based on at least one updated content list.

An example system includes a sensing module for receiving at least one transient stimulus. The system also includes a rule and action module for checking one or more rules for the at least one transient stimulus and updating content list dynamically based on result of the checking. Further, the system includes a play module for playing contents based on updated content list.

An example machine-readable medium product includes instructions operable to cause a programmable processor to perform receiving at least one transient stimulus. A content list is then dynamically updated based on one or more rules corresponding to the at least one transient stimulus. Thereafter, contents are played based on updated content list.

### BRIEF DESCRIPTION OF THE DRAWINGS

FIG. 1 is a block diagram of a system in accordance with an embodiment of the invention;

FIG. 2 is a block diagram of a processor in accordance with an embodiment of the invention; and

FIG. 3 is a flowchart illustrating a method for intelligently playing contents in accordance with an embodiment of the invention.

### DETAILED DESCRIPTION OF THE EMBODIMENTS

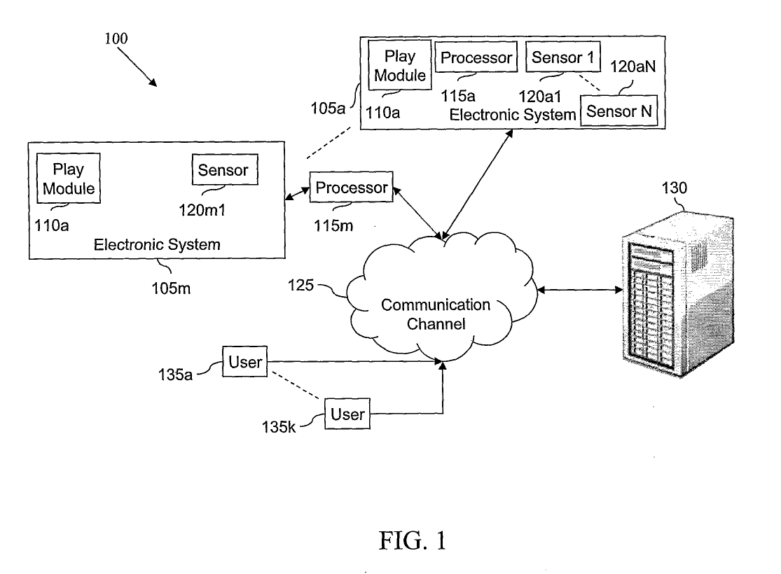

FIG. 1 is a block diagram of a system 100 in accordance with an embodiment of the invention. System 100 includes one or more electronic systems, for example, an electronic system 105a and an electronic system 105b. System 100 may be a public or a private network.

Examples of the one or more electronic systems include but are not limited to electronic display system, display systems, display boards, billboards, mobile devices, televisions, music players, loud speakers, digital displays, combination of a display device and a music player, or any other electronic system capable of playing content.

In an embodiment of the invention, the one or more electronic systems have inbuilt adequate processing power and requisite software to play the contents. For example, electronic system 105a includes a play module 110a, a processor 115a and one or more sensors, for example, sensor 120a1 and sensor 120aN. In another embodiment of the invention, electronic system 105 may be connected to one or more devices for adequate processing power and requisite software purposes. For example, electronic system 105b including a play module 110b, sensor 120m1 and sensor 120mN is connected to a processor 115b.

Play module 110a and play module 110b play contents based on corresponding content list. In an embodiment of the invention, a play module may include both a display device and a player. A play module, for example, a screen includes several screen lets. Each screen let may be assigned a unique id for reporting purpose. The play module gets a personality based on various factors, for example, local static data, local transient data, remote static data, remote transient data, historical usage data and combinations thereof.

In an embodiment of the invention, the one or more sensors sense information at a predetermined frequency. Examples of the one or more sensors include but are not limited to temperature sensor, digital camera, infrared sensor, ultrasound sensor, microphone, video recorder, Global Positioning System (GPS) device and combinations thereof. Examples of sensed information include but are not limited to temperature, noise level, lighting, humidity, precipitation, wind speed, images, videos, people activity, words spoken by people, change in location, count of people, items, number of devices held by people, user inputs from nearby using public telecommunication or internet networks, and combinations thereof.

In an embodiment of the invention, the predetermined frequency may be set by one or more users, for example, a user 135a and a user 135k.

In an embodiment of the invention, the one or more users include one or more content owners.

In an embodiment of the invention, a processor corresponding to the one or more sensors receives and processes the transient stimuli, and updates content lists for corresponding electronic systems. For example, sensor 120a1 sends at least one transient stimulus to processor 115a which then processes the at least one transient stimulus and updates content list.

Processor 115a and processor 115b communicate with a server 130 using a communication channel 125. Examples of communication channel 110 include but are not limited to wired channels, wireless, terrestrials, satellites, Local Area Networks (LAN), Wide Area Networks (WAN), Metropolitan Area Networks (MAN), intranet, and internet.

In an embodiment of the invention, one or more processors also receives transient stimulus from a remote source through communication channel 125. Examples of the remote source include but are not limited to web updates and other services like weather forecasts. For example, if an Intellectual Property Rights conference detail is updated or posted on the web then communication channel 125 sends corresponding transient stimulus to the one or more processors which then decides to play law firms related files or other related content. In another embodiment of the invention, the transient stimulus form the remote source may be handled by server 130 which then sends the related content automatically to the one or more processors.

In an embodiment of the invention, server 130 includes repository of contents that need to be played. The contents may be categorized as “list of files which are not tagged to any transient stimulus”, “list of files to be used as fillers in case of no transient stimulus” and “list of files which are specifically tagged to at least one transient stimulus”.

In an embodiment of the invention, options may be provided to the one or more users to set up rules for updating the content lists.

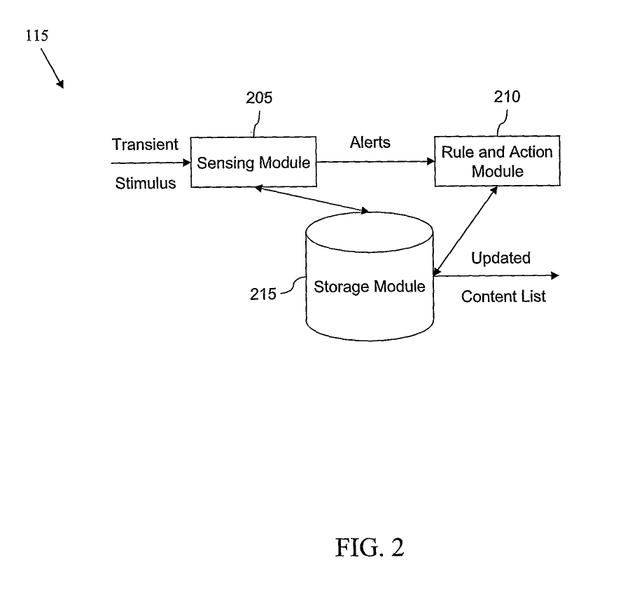

In an embodiment of the invention, the one or more processors include one or more modules for dynamically updating the content lists. A processor including several modules is explained in detail in conjunction with FIG. 2.

FIG. 2 is a block diagram of a processor 115 in accordance with an embodiment of the invention. Processor 115 includes a sensing module 205, a rule and action module 210 and a storage module 215. In an embodiment of the invention, processor 115 has an embedded operating system. Processor 115 may also change settings of an electronic system or other associated components.

Sensing module 205 receives at least one transient stimulus. In an embodiment of the invention, sensing module 205 pre processes the at least one transient stimulus by interpreting it and generating alerts corresponding to it. For example, if the at least one transient stimulus is an image then the processing may include counting number of people in the image and sending the count to a rule and action module 210.

In an embodiment of the invention, sensing module 205 may also check one or more thresholds. Based on the checking, sensing module 205 may then generate the alerts. For example, checking if the count of the people is more than three and then generating the alert.

Rule and action module 210 receives the alerts for the at least one transient stimulus and checks one or more rules corresponding to those alerts or corresponding to the at least one transient stimulus. Based on the checking, rule and action module 210 updates content list dynamically. In an embodiment of the invention, rule and action module 210 includes a logic layer which factors transient stimuli from a local source and a remote source, and assembles the content list.

The personality of a player is based on various factors, for example, local static data, local transient data, remote static data, remote transient data, historical usage data and combinations thereof. These factors define vector state of the player. In an embodiment of the invention, rule and action module 210 compares the vector state to rules stored in a rules database, for example, storage module 215. The rules database may vary across different players.

In an embodiment of the invention, the content list is stored in storage module 215. Rule and action module 210 updates the content list to give the updated content list. Storage module 215 may store all the files in a coded manner to prevent any misuse.

In an embodiment of the invention, storage module 215 may store metadata of all the files tagged for the at least one transient stimulus and other playing information. Storage module 215 in conjunction with rule and action module 210 may also download the files with play information from the central server through a secured connect layer. Storage module 215 capacity may be optimized, for example, by referring rules with some references.

In an embodiment of the invention, rule and action module 210 maintains a record of its actions in storage module 215 as a proof for future research. The record may include information about the decisions taken corresponding to the transient stimuli. Further, storage module 215 may also maintain a record of the playing for future research and reporting.

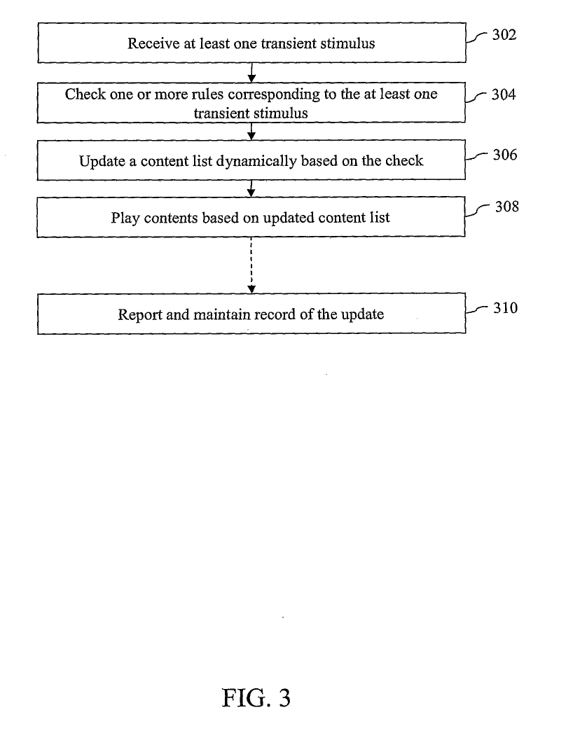

FIG. 3 is a flowchart illustrating a method for intelligently playing contents in accordance with an embodiment of the invention. A player plays contents based on a content list. The content list may vary from player to player.

At step 302, at least one transient stimulus is received. The at least transient stimulus may be received from a local source or a remote source. The remote source includes remote static data, remote transient data, web updates and other services like weather forecasts. The local source includes sources sensing or detecting local static data, local transient data and other local variables, for example, temperature, noise level, lighting, humidity, wind speed, images, videos, people activity, words spoken by people, change in location, count of people, items, number of devices held by people, user inputs from nearby using public telecommunication or interne networks, and combinations thereof. In an embodiment of the invention the sensing or detecting is performed at predetermined frequency. The predetermined frequency may be set by one or more users.

In an embodiment of the invention, the at least one transient stimulus may be pre-processed by interpreting it and checking one or more thresholds. For example, if the at least one transient stimulus is an image then the pre-processing may include counting number of people in the image and sending the count. In another embodiment of the invention, the pre-processing may also include checking a threshold. If the threshold is breached then alerts are generated.

At step 304, one or more rules corresponding to the at least one transient stimulus are checked. In an embodiment of the invention, the one or more rules may be set by users. The one or more rules vary across different player. The one or more rules may indicate that some action should be taken, for example, content should be included in the content list or removed from the content list if a condition or combination of conditions is satisfied. In an embodiment of the invention, the one or more rules also include rules corresponding to play time of the content list. The one or more rules may be corresponding to local static data, local transient data, remote static data, remote transient data, historical usage data or analytical data.

In another embodiment of the invention, the one or rules may be set independent of the users or a central server. The one or more rules may be gathered from previous decisions taken under similar situations.

Thereafter at step 306, the content list is updated dynamically based on checking of the one or more rules. In an embodiment of the invention, option may be provided to update the content list at particular frequency instead of updating the content list at that instant.

In an embodiment of the invention, the content list is updated independent of the users or a network operator or a central server or manual intervention. In another embodiment of the invention, options may be provided to a user to override the updating. The updating may be different for different players for the same rules.

At step 308, contents are played based on updated content list. In an embodiment of the invention, playing includes displaying along with playing an audio.

It will be appreciated that checking of the one or more thresholds and the one or more rules may be processed simultaneously. Based on the checking corresponding triggers may be generated. These triggers may then lead to different actions on different players.

In an embodiment of the invention, at step 310, the update performed is reported and stored to maintain a record of the decisions taken on receipt of the at least one transient stimuli. Further, the playing information is also stored and maintained for future use.

It will be appreciated that options may be provided to a user to override the actions corresponding to the transient stimulus. For example, the overriding for remote sources may be controlled using the central server. The overriding may be applied locally or from remote locations.

In an embodiment of the invention, a generalized pseudocode for the method described includes the following:

A system is defined by attributes which are constantly updated. The system attributes include:

| | |
|---|---|
| {System Attributes} [symbol] | {System Local Transient Attributes} |
| | {System Local Static Attributes} |
| | {System Remote Transient Attributes} |
| | {System Remote Analytical Attributes} |

Thus, Attribute<n> ‘Element of’ {System Attributes}

The system has certain ‘Rules’ defined in the system database (based on system attributes) as

| | | |
|---|---|---|
| Rule_ID | Conditional Expression <Equation expressed | Desired |
| <numeric ID> | as a combination of System Attributes and | Action |
| | Threshold Values> | |

where Conditional Expression [symbol] Cond1 & Cond2 OR Cond3 . . . ,

(Cond<n> [symbol] (Attribute<n>, Threshold Value, Relation (Attribute<n>, Threshold Value)))

(Relation [symbol] Greater, Lesser or Equal)

i.e. the conditional expression becomes

(Attribute<1> GT Threshold Value) & (Attribute<2> LT Threshold Value) OR (Attribute<3> EQ Threshold Value)

The system continually invokes a service periodically, referred as ‘Periodic_System_Check_For_Rules_Defined’. The service includes the following:
a) Scans through the ‘Rules’ defined for the system.
b) Evaluates conditions defined for every ‘Rule’
c) Determines whether to invoke the desired action if the necessary conditions are met.

Periodic_System_Check_For_Rules_Defined( )

{

While(1) //Continuous loop
{

Execute Rule_check( );
Sleep(N Seconds);

}

}

Rule_check( )

{

For Rule_ID in Rule_Sets(Rule_ID=1...n)

{ // Rule-Sets is obtained from the ‘Rules’ defined for the system

Take_Action = False; // Flag set to determine if action is to be taken
Parser_Invoked( ); // Parser converts the Condition Expression into

Attributes and Threshold values

For Attribute in Rule_Sets[Rule_ID] {
If( Rule_Sets [Rule_ID][Attribute] Matches (Condition( )) )
{

Take_Action = True;

}
else

Take_Action = false;

}

}
if(Take_Action = True) {

Execute Action(Rule_Set[Rule_ID]);

}

}

}
Parser_Invoked( )
{

// Converts the Conditional Expression into a set of Attributes and Threshold Values.

}
Condition( )
{

// Threshold Condition Returned for the particular Attribute defined for the particular
Rule_ID for the Rule_Set

}
Matches( )
{

// Obtains the system ‘Attribute’ value and compares ‘Threshold’ value defined. Returns

true or false based on whether the condition is met or not.
}
Action( )
{

// Action as defined in the database for the particular Rule_ID

}

The method described above is explained with help of some examples below:

### EXAMPLE 1

A player plays contents of a content list as per predetermined schedule. The playing time of the content list is one minute. For first thirty seconds the schedule is fixed and includes playing files which are not tagged to any transient stimulus. For the next thirty seconds the schedule is not fixed and includes playing files which are to be used as fillers in case of no transient stimulus.

As per predetermined schedule next display was to be that of a music CD. A voice sensor then determines a loud procession, greater than 50 decibel, in the vicinity of the player and sends a noise stimulus. A processor receives the transient stimulus and looks at threshold of 30 decibel corresponding to the transient stimulus. As 50 decibel is greater than 30 decibel the threshold is breached. The processor then generates an alert. The alert then leads to checking of one or more rules corresponding to the breach of the threshold.

If the rule says not to display the music CD advertisement and instead display an advertisement of a quiet place then the processor updates the content list by inserting the advertisement of a quiet place that does not pertain to audio. The player then plays the newly inserted advertisement as per updated content list.

If the rule says not to display the music CD advertisement and instead display an advertisement of a quiet place only if the music CD advertisement is placed in the unfixed schedule then the processor checks where the music CD advertisement is placed to be displayed. If the music CD advertisement falls under fixed schedule then no change is made. Else, the music CD advertisement is replaced.

In an embodiment of the invention, if the unfixed schedule slots are filled by advertisements based on the one or more rules then the playing time may be stretched to accommodate additional advertisements.

In an embodiment of the invention, the stretching limit of the playing time may be increased up to 20%.

### EXAMPLE 2

A digital camera in a mobile device captures image of people. A processor attached to the mobile device processes image and counts number of people in the image. The processor then categorizes them, checks threshold and then decides to play content based on one or more rules corresponding to the number of people. For example, if the rule says for more than 10 people play audio that there is x% discount at a near by store, where x is the number of the people.

### EXAMPLE 3

Details related to a Java conference which is scheduled to be held in Chicago is uploaded or posted on the web. A central server gets the transient stimulus corresponding to the conference and sends command to processors attached to electronic systems in Chicago to display advertisement of Microsoft, Sun etc.

The processors may also get the transient stimulus directly and the processors may then process the transient stimulus. The processors present in Chicago meets the condition of presence in Chicago and these processors may then display relevant advertisement without involving a central server or content owner or a network operator.

In an embodiment of the invention, combination of transient stimuli may also be handled. For example, based on stimuli like temperature with location and noise level surrounding a display varied and contextual set of contents is played. A truck carrying a player on a wet day may deliver content relating to keeping homes dry or umbrellas. The same truck on a different sunny day in the same area may deliver content relating to picnic spots.

In another example, lighting conditions may be checked based on an automated mechanism and depending on the light brightness and contrast level of electronic display may be adjusted.

In yet another example, discount coupon or sales promotion information may be delivered when a certain number of people with a particular device are in front of the electronic system.

In still another example, location of a truck carrying a display may be determined using GPS and based on the location advertisements may be delivered. For example, near ocean yachts may be shown and the same display may show information on law firms in downtown district.

It will be appreciated that there may be several other local variables or remote services which may be processed using the method described in FIG. 3.

In an embodiment of the invention, one or more steps of the method described in FIG. 3 may be implemented using a machine-readable medium product. Examples of the machine-readable medium product include but are not limited to memory devices, tapes, disks, cassettes, integrated circuits, servers, online softwares, download links, installation links, and online links.

The choice of playing a content based on transient stimuli is left to an electronic system itself which reduces manual intervention like content owner participation or of a network operator. Further, impact of any content is multiplied by playing proper content when desired.

The foregoing description sets forth numerous .specific details to convey a thorough understanding of embodiments of the invention. However, it will be apparent to one skilled in the art that embodiments of the invention may be practiced without these specific details. Some well-known features are not described in detail in order to avoid obscuring the invention. Other variations and embodiments are possible in light of above teachings, and it is thus intended that the scope of invention not be limited by this Detailed Description, but only by the following Claims.

What is claimed is:

1. A method comprising:
receiving at least one transient stimulus;
updating content list dynamically based on one or more rules corresponding to the at least one transient stimulus; and
playing contents based on updated content list.

2. The method of claim 1, wherein the receiving comprises:
receiving the at least one transient stimulus from a local source or a remote source.

3. The method of claim 1 further comprising:
pre-processing the at least one transient stimulus.

4. The method of claim 1, wherein the updating comprises:
varying play time of the content list based on a predetermined threshold.

5. The method of claim 1 further comprising:
maintaining a record of the playing.

6. The method of claim 1 further comprising:
maintaining a record of the updating.

7. The method of claim 1 further comprising:
detecting the at least one transient stimulus at a predetermined frequency.

8. A method comprising:
playing at least one content list on at least one electronic system;
receiving at least one transient stimulus for the at least one electronic system from a remote source or a local source;
checking one or more rules for the at least one transient stimulus;
updating the at least one content list dynamically based on result of the checking; and
playing contents based on at least one updated content list.

9. A system comprising:
a sensing module for receiving at least one transient stimulus;
a rule and action module for checking one or more rules for the at least one transient stimulus and updating content list dynamically based on result of the checking.

10. The system of claim 10 further comprising:
one or more sensors for detecting the at least one transient stimulus.

11. The system of claim 10 further comprising:
a storage module for maintaining a record of the playing.

12. The system of claim 10 further comprising:
a play module for playing contents of updated content list.

13. A machine-readable medium product comprising instructions operable to cause a programmable processor to perform:
receiving at least one transient stimulus;
updating content list dynamically based on one or more rules corresponding to the at least one transient stimulus; and
playing contents based on updated content list.

14. The machine-readable medium product of claim 13, wherein the receiving comprises:
receiving the at least one transient stimulus from a local source or a remote source.

15. The machine-readable medium product of claim 13 further comprising instructions operable to cause a programmable processor to perform:
pre-processing the at least one transient stimulus.

16. The machine-readable medium product of claim 13, wherein the updating comprises:
varying play time of the content list based on a predetermined threshold.

17. The machine-readable medium product of claim 13 further comprising instructions operable to cause a programmable processor to perform:
maintaining a record of the updating.

18. The machine-readable medium product of claim 13 further comprising instructions operable to cause a programmable processor to perform:
maintaining a record of the playing.

19. The machine-readable medium product of claim 13 further comprising instructions operable to cause a programmable processor to perform:
detecting the at least one transient stimulus at a predetermined frequency.
